(19) United States
(12) Patent Application Publication
(10) Pub. No.: US 2006/0256144 A1
(43) Pub. Date: Nov. 16, 2006

(54) Portable computer with image-projecting function

(76) Inventor: Cheng Huan Chung, Taipei City (TW)

Correspondence Address: HDSL, 4331 STEVENS BATTLE LANE, FAIRFAX, VA, 22033, US

(21) Appl. No.: 11/354,020

(22) Filed: Feb. 15, 2006

(30) Foreign Application Priority Data
May 11, 2005 (CN) 200510069120.8

(51) Int. Cl. G09G 5/00

(52) U.S. Cl. 345/905

(57) ABSTRACT

A portable computer includes a main computer body having a micro-projector built therein, and a projection panel attached to the main computer body to constitute a portable computer displaying images in a projecting manner. The micro-projector includes an opto-mechanical system and a projecting system. The opto-mechanical system receives an image signal from the main computer body and outputs a light signal to the projecting system. The projecting system then convents the light signal into a digital image signal and projects the digital image to a projection panel in a manner of front or rear projection. The projecting distance between the projection panel and the micro-projector may be adjusted. The projection panel may also separate from the main computer body and supported by a support base. Increasing the projecting distance can enlarge the projecting image size. A portable computer system integrated with the micro-projector and having a large display is thus achieved.

### BACKGROUND OF THE INVENTION

1. Field of The Invention

The present invention relates generally to portable computers with image-projecting function, and more particularly to a portable computer having a micro-projector built therein and a projection panel attached thereto to take the place of a liquid crystal display of the portable computer.

2. Description of Related Arts

Nowadays, with the upswing of the consciousness of environmental protection all over the world, certain products that can cause considerable environment pollution have been reduced in quantity or even banned in many countries. On the other hand, as a result of rapid developments in the display industry, the production of TV sets, personal computers, notebook computers and outdoor displays increases year by year. This is especially the case for displays of the TV sets and computers that can be seen everywhere. This makes the environment pollution even worse. For liquid crystal display panels (LCD Panels) of typical notebook computers, their manufacture needs the mass application of chemical and semiconductor processing technologies, which may bring severe environmental pollution issue. Among various flat panel display technologies, only the light projecting technology does not cause environment pollution and is therefore considered to be the best as far as the environmental protection is concerned.

In addition, to meet the consumer's needs for portable products, the notebook computers and projectors have been developed toward low profile and low weight to achieve the portability in recent years. In particular, design of the projector has been focused on the low profile, the low power consumption and the capability of use in various situations such as outdoor/indoor use or day/night use. Unfortunately, as the notebook goes smaller, the liquid crystal display becomes smaller. This will cause a problem that it is inconvenient to watch the image or characters on the display. Therefore, the notebook computer can not be made even smaller. It is thus desired to develop a computer system having both a main computer body with a minimum size and a display with a maximum size.

To address the above-mention problems and needs, the present invention provides a portable computer with an image-projecting function.

### SUMMARY OF THE INVENTION

The present invention is to provide a portable computer with an image-projecting function, which has a micro-projector built therein to integrate the portable computer with the image-projecting function.

Another, the present invention is to provide a portable computer with an image-projecting function, which has a projection panel to take the place of a liquid crystal display of the portable computer. This can avoid using complicated and high technology to manufacture the liquid crystal display and therefore reduce the cost. This can also prevent the pollution of heavy metals during the manufacture of the liquid crystal display.

Further, the present invention is to provide a portable computer with an image-projecting function, which can readily project the image to the projection panel without the need of a projection wall or screen and can freely adjust the projecting image size by adjusting the distance between the micro-projector and the projection panel.

Accordingly, the present invention provides a portable computer with an image-projecting function. The portable computer includes a main computer body and a micro-projector built in the main computer body. The main computer body has conventional computing and memory capabilities, and includes conventional computer peripheral devices such as a keyboard, a floppy disk drive and a hard disk drive. The micro-projector includes an opto-mechanical system and a projecting system. The micro-projector includes a link interface for receiving an image signal from the main computer body. The opto-machanical system outputs a light signal to the projecting system according to the image signal. The projecting system then convents the light signal into a digital image signal and projects the digital image to a projection panel. The projection panel may be attached to the main computer body. The projecting image size can be readily adjusted by adjusting the distance between the micro-projector and the projection panel. The projection panel may also be configured to separate from to the main computer body and supported by a support base. The portable computer is integrated with the micro-projector and the projection panel. The micro-projector may project the image to the projection panel in a manner of front projection or rear projection. The projection panel takes the place of the liquid crystal display of the portable computer, the user can then obtain a larger display image size. A portable computer having a main computer body with a minimum size and a display with a maximum size can thus be achieved.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a schematic view showing a projection panel attached to a main computer body in accordance with the present invention;

FIG. 2 is a schematic view showing a movable locking latch for increasing the projection distance in accordance with the present invention;

FIG. 3 is a schematic showing the configuration of the present invention using a rear projecting techlogy;

FIG. 4 is a schematic view showing a strechable projection panel in a streched state in accordance with the present invention;

FIG. 5 is a side view of the strechable projection panel in accordance with the present invention;

FIG. 6 is a schematic view showing the configuration of the present invention in which the projection panel separates from the main computer body;

FIG. 7 is a schematic view showing the configuration of the opto-mechanical system of the micro-projector in accordance with the present invention;

FIG. 8 is a schematic view showing the configuration of the projecting system of the micro-projector in accordance with the present invention;

FIGS. 9 and 10 are schematic views respectively showing the light source of the opto-mechanical system is focused in two different manner; and

FIG. 11 is a schematic view showing a micro-projector built in a notebook computer and projecting an image signal to a projection screen.

### DESCRIPTION OF PREFERRED EMBODIMENTS

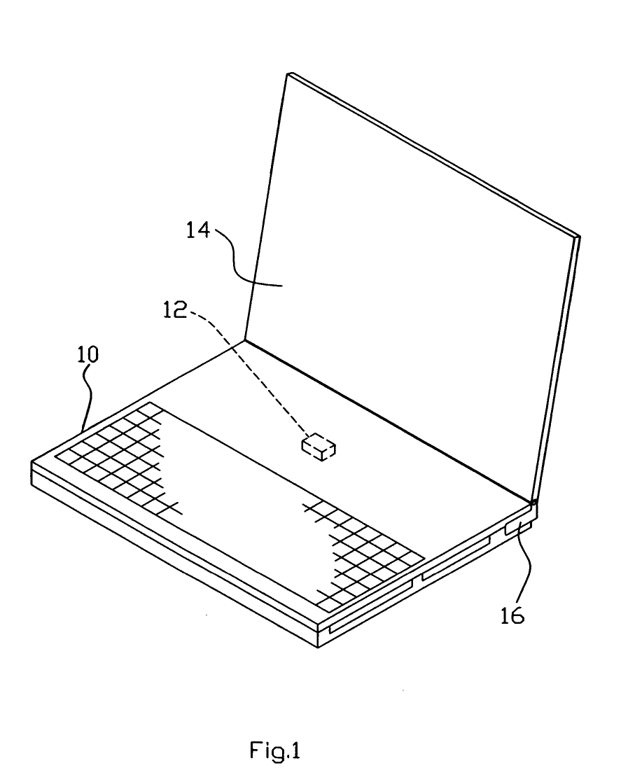

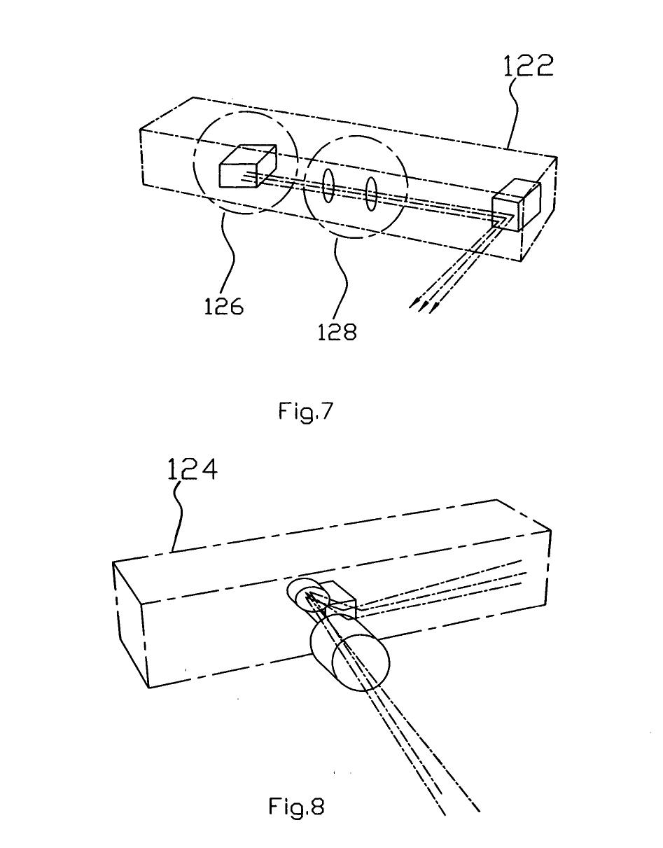

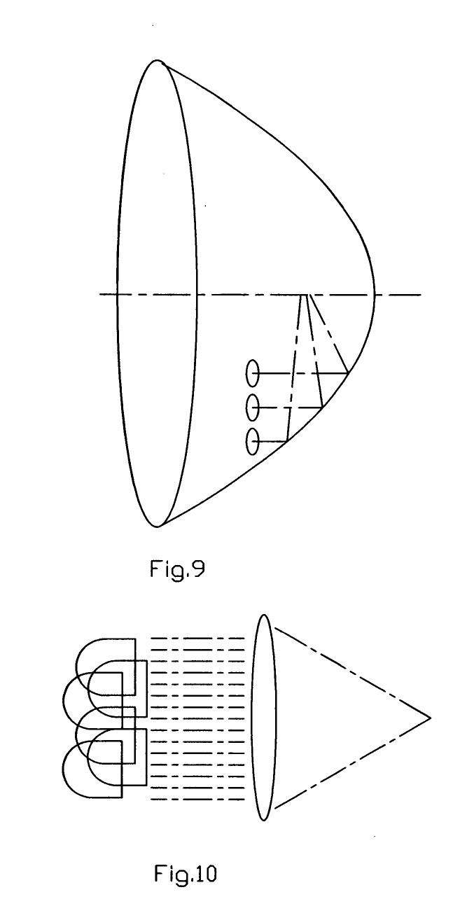

Referring to FIGS. 1 through 3, a portable computer with an image-projecting function according to the present invention comprises a main computer body 10 and a micro-projector 12 built in the main computer body 10. The main computer body 10 has conventional computing and memory capabilities, and comprises conventional computer peripheral devices such as a keyboard, a floppy disk drive and a hard disk drive. The micro-projector 12 can be an LCOS (Liquid Crystal On silicon) or DLP (Digital Light processing) type projector, and comprises an opto-mechanical system 122 (FIG. 7) and a projecting system 124 (FIG. 8). The micro-projector 12 comprises a link interface (not shown) for receiving an image signal from the main computer body 10. The link interface may be one of the VGA, COM, LPT or USB port. The opto-mechanical system 122 outputs a light signal to the projecting system 124 according to the image signal from the main computer body 10. The projecting system 124 then convents the light signal into a digital image signal and projects the digital image to a projection panel 14. The configuration of the opto-mechanical system 122 and the projecting system 124 are illustrated in FIGS. 7 and 8 respectively. The opto-mechanical system 122 comprises a light source unit 126 and a lens unit 128. In operation, the light source unit 126 generates a light directed to the lens unit 128. The light is substantially directional and its brightness can be adjusted by the light source unit 126. The light can be focused in a manner as illustrated in FIG. 9, in which a concave reflector 127 is used to reflect and focus the light into a light spot. Afterwards, the focused light is reflected to the projecting system 124 by the lens unit 128. Alternatively, the light may be focused in another manner as illustrated in FIG. 10, in which a convex lens 2127 is disposed in front of the light source unit 126 to focus the light into a light spot. The focused light is then reflected to the projecting system 124 by the lens unit 128.

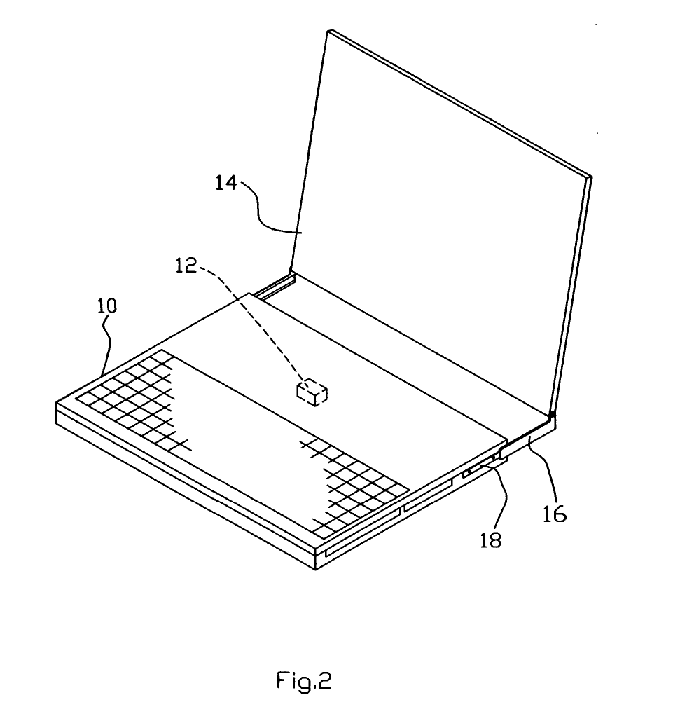

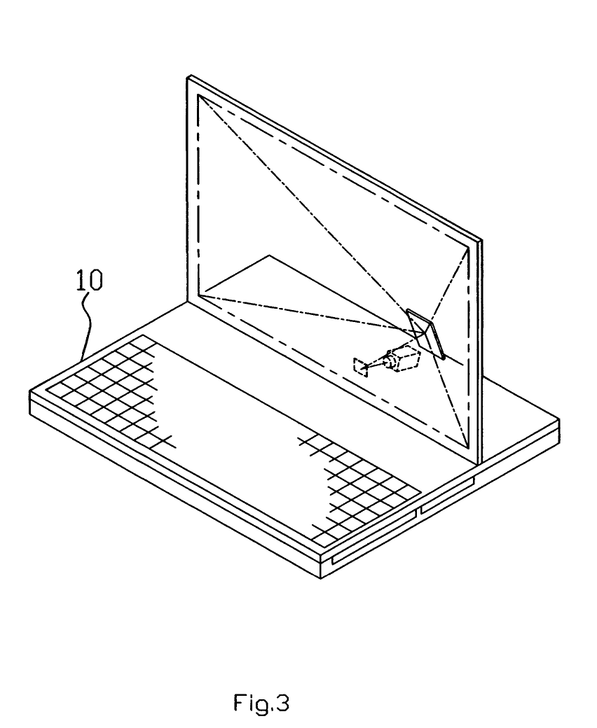

The projection panel 14 comprises a single panel with a fixed size, and may be made from metal, alloy, polymer, ceramic, glass, composite material or electrochromic material. Two sliding locking latches 18 are formed at opposite sides of the main computer body 10. Two movable connecting members 16 are fixed to the projection panel 14. The projection panel 14 is attached to the main computer body 10 by the movable connecting members 16 movably attached to the sliding locking latches 18. Therefore, the projection panel 14 is movable with respect to the main computer body 10. By this configuration, the projection panel 14 may share one computer case with the main computer body 10. Alternatively, the projection panel 14 may directly serve as an outer cover of the main computer body 10. The projection panel 14 has two opposite flat surface, i.e., front and rear surfaces. The front surface can be used as a projection surface of a front projection; and the rear surface can be used as a projection surface of a rear projection as shown in FIG. 3. The images projected from the micro-projector 12 are reflected to the rear surface of the projection panel 14 by a reflecting mirror 20. A user can see the image from a front side of the projection panel 14. Whether sharing one computer case with the main computer body 10 or serving directly as the outer cover of the main computer body 10, the projection panel 14 can be made from materials different from that of the main computer body 10. Referring to FIG. 2, in the case of front projection, the distance between the projection panel 14 and the lens of the micro-projector 12 is named as projection distance. The user can move the projection panel 14 relative to the main computer body 10 to adjust the projection distance, thereby adjusting the image size. Referring to FIG. 3, in the case of rear projection, the projection panel 14 spaces the lens of the micro-projector 12 with 6 centimeters, and can move relative to the micro-projector 12 to adjust the distance therebetween. In addition, the micro-projector 12 can be rotated so that it can project the image to a place other than the projection panel 14. In this situation, the micro-projector 12 is used as an ordinary projector. Furthermore, the micro-projector 12 may comprise connecting interfaces or connecting slots, for connecting external devices of various functions.

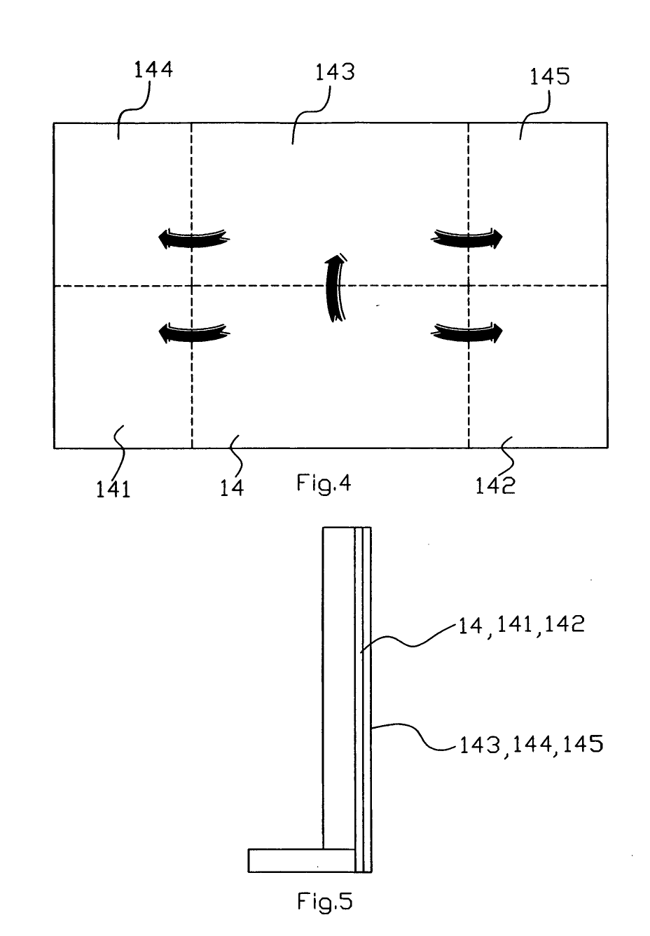

The projection panel 14 as shown in FIGS. 1 through 3 comprises a single panel, and therefore has a fixed size. Referring to FIGS. 4 and 5, alternatively, a plurality of other panels can be stacked behind the projection panel 14, to form a stretchable projection panel. In this embodiment, the other panels comprise five panels, i.e., a left projection panel 141, a right projection panel 142, a top projection panel 143, a top left projection panel 144 and a top right projection panel 145. A plurality of movable locking latches (not shown) is formed between these other panels and the projection panel 14, along which these other panels can be stretched out and moved forwardly or rearwardly with respect to the micro-projector, thereby forming a large flat projection screen. Similar to the projection panel as shown in FIG. 1, the stretchable projection panel can be attached to the main computer body 10 by the movable connecting member 16. The stretchable projection panel may share one computer case with the main computer body 10, or directly serves as an outer cover of the main computer body 10. In the latter situation, an flat inner surface can be used as a projection surface. Whether sharing one computer case with the main computer body 10 or serving directly as the outer cover of the main computer body 10, the stretchable projection panel can be made from materials different from that of the main computer body 10.

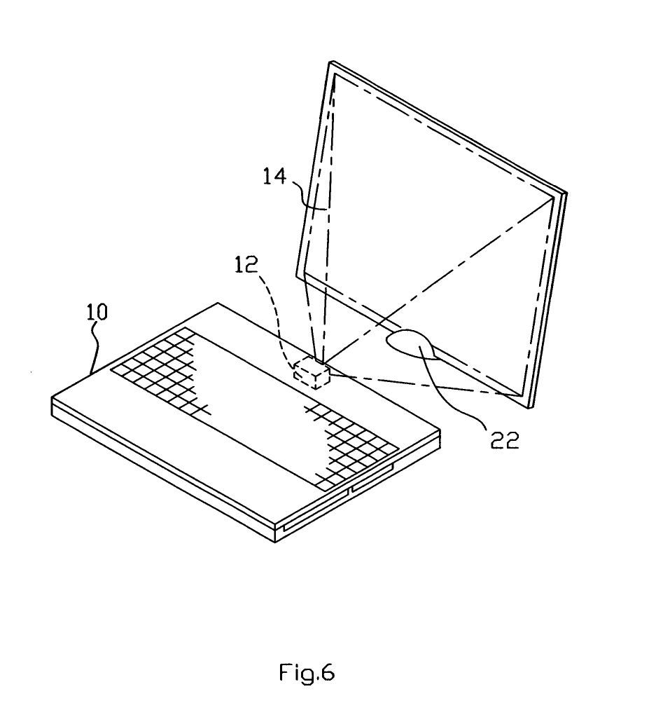

Referring to FIG. 6, the projection panel 14 may also be detached from the main computer body 10 and supported by a support base 20. The distance between the support base 20 and the micro-projector 12 is the projection distance. After the main computer body 10 transmits an image signal to the micro-projector via the link interface, the micro-projector 12 projects the image signal to the projection panel 14, thereby the image is shown on the projection panel 14. The projection panel 14 may be a single panel with a fixed size, or a stretchable projection panel as described above. In this embodiment, the projection panel 14 is configured to separate from the main computer body 10. Therefore, the projection panel 14 can separate from the computer case of the main computer body 10, thereby protecting the projection panel 14 from being damaged or polluted. In addition, the user can readily replace the projection panel with other projection panels made from different materials. Furthermore, the user can increase the projection distance within a range the micro-projector allows to obtain a larger projecting image.

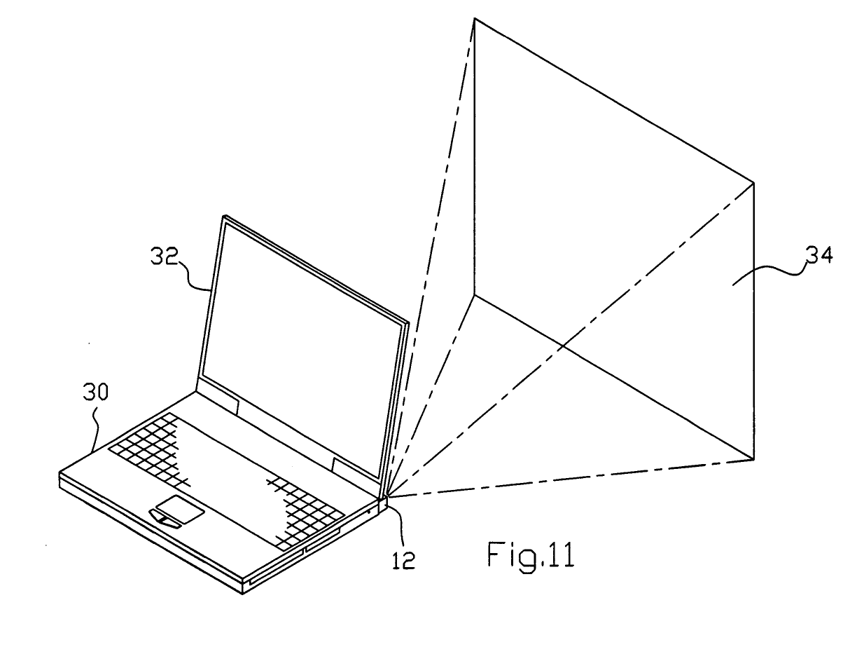

Referring to FIG. 11, in addition to be built in the above-described main computer body 10, the micro-projector 12 can also be built in a notebook computer 30 having a liquid crystal display 32. The notebook computer 30 comprises a display switch (not shown) to switch the display manner thereof. This enables the notebook computer 30 to selectively show the image signal on the liquid crystal display or project the image signal to a projection screen 34. The micro-projector 12 can be rotated to adapt to positions of the projection screen 34. In addition, the micro-projector 12 may comprises link interfaces or connecting slots, for connecting external devices of various functions.

In general, the present invention provides a computer system that has a micro-projector built in a portable computer and has a projection panel to take the place of the liquid crystal display of the portable computer. By using front or rear projection technologies, the micro-projector can project the image signal of the portable computer to the projection panel. The projection panel may be attached to the portable computer; it may also be configured to separate from the portable computer. The projection panel may stretch out to form a larger projection panel. This can prevent the pollution of heavy metal during the manufacture of the liquid crystal display, and avoid using complicated and high technology to manufacture it and therefore reduce the cost. In addition, the user can freely adjust the projecting image size by adjusting the distance between the micro-projector and the projection panel.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

We claim:

1. A portable computer with an image-projecting function, comprising:
a main computer body having computer's computing capability and comprising a keyboard, a floppy disk drive and a hard disk drive;
a micro-projector built in the main computer body, the micro-projector comprising an opto-mechanical system and a projecting system for projecting an image signal generated by the main computer body; and
a projection panel, being an outer cover of the main computer body and being separable from the main computer body, wherein a lens unit of the micro-projector is able to project the image to the projection panel.

2. The portable computer with an image-projecting function of claim 1, wherein the image signal is transmitted from the main computer body to the micro-projector via a link interface.

3. The portable computer with an image-projecting function of claim 2, wherein the link interface is selected from the group consisting of VGA, COM, LPT and USB port.

4. The portable computer with an image-projecting function of claim 1, wherein the micro-projector comprises one of a link interface and a connecting slot for connecting external devices of various functions

5. The portable computer with an image-projecting function of claim 1, wherein the micro-projector can be rotated.

6. The portable computer with an image-projecting function of claim 1, wherein the micro-projector is a DLP type or a LCOS type projector.

7. The portable computer with an image-projecting function of claim 1, wherein the micro-projector projects the image to the projection panel in a manner of one of the front projection and rear projection.

8. The portable computer with an image-projecting function of claim 1, wherein the opto-mechanical system further comprises a light source unit and a lens unit.

9. The portable computer with an image-projecting function of claim 8, wherein the light source generates a substantially directional light, a concave reflector is used to reflect and focus the substantially directional light into a light spot, and the focused light is reflected to the projecting system by the lens unit.

10. The portable computer with an image-projecting function of claim 8, wherein a convex lens is disposed in front of the light source unit to focus a light generated by the light source unit into a light spot, and the focused light is then reflected to the projecting system by the lens unit.

11. The portable computer with an image-projecting function of claim 1, wherein the projection panel is attached to the main computer body with a movable connecting member.

12. The portable computer with an image-projecting function of claim 1, wherein the projection panel is supported by a support base, and the projection panel is able to be replaced with other projection panel made of different materials.

13. The portable computer with an image-projecting function of claim 11, wherein the movable connecting member comprises a slide part for increasing or reducing the distance between the projection panel and the micro-projector.

14. The portable computer with an image-projecting function of claim 1, wherein the projection panel is made of a material selected from the group consisting of metal, alloy, polymer, ceramic, glass, composite material and electrochromic material.

15. The portable computer with an image-projecting function of claim 1, wherein the projection panel shares one computer case with the main computer body.

16. The portable computer with an image-projecting function of claim 1, wherein the material of the projection panel is different from that of the main computer body.

17. The portable computer with an image-projecting function of claim 1, wherein the projection panel is one of a projection panel comprising a single panel with a fixed size and a stretchable projection panel.

18. The portable computer with an image-projecting function of claim 17, wherein the stretchable projection panel comprises a plurality of panels being stretchable to form a large projection screen.

19. The portable computer with an image-projecting function of claim 18, wherein a plurality of movable locking latches is formed between the plurality of panels to enable the panels to be moved forwardly or rearwardly with respect to the micro-projector.

20. A notebook computer with an image-projecting function, comprising:
a notebook computer; and
a micro-projector built in the notebook computer, wherein in operation, an image signal generated by the notebook is transmitted to the micro-projector via a link interface, and projected out by the micro-projector.

21. The notebook computer with an image-projecting function of claim 20, wherein the link interface is selected from the group consisting of VGA, COM, LPT and USB port.

22. The notebook computer with an image-projecting function of claim 20, wherein the micro-projector comprises one of a link interface and a connecting slot for connecting external devices of various functions.

23. The notebook computer with an image-projecting function of claim 20, wherein the micro-projector can be rotated.
